(19) United States
(12) Patent Application Publication
(10) Pub. No.: US 2026/0252828 A1
(43) Pub. Date: Aug. 27, 2026

(54) CARD READER

(71) Applicant: NIDEC INSTRUMENTS CORPORATION, Nagano (JP)

(72) Inventors: Mamoru MIZAWA, Nagano (JP); Ryo UCHIYAMA, Nagano (JP)

(21) Appl. No.: 19/550,254

(22) Filed: Feb. 26, 2026

(30) Foreign Application Priority Data
Feb. 27, 2025 (JP) 2025-030078

(51) Int. Cl. G06K 7/00; G06K 7/08

(52) U.S. Cl. CPC G06K 7/0021; G06K 7/087

(57) ABSTRACT

A card reader 100 includes a cover member 2 including a front wall portion 4 in which an insertion slot 15 for inserting a card 10 is formed, and a card reader main body portion 9 capable of accessing information recorded on the card 10 inserted through the insertion slot 15. A hard coat layer 11 is provided on a front surface 41 of the front wall portion 4 and a surface 51 of an opening edge portion forming the insertion slot 15. The cover member 2 includes a guide portion 5 forming a transport path 50 extending from the insertion slot 15 toward a rear side X2. The hard coat layer 11 is provided on a surface 51 of the guide portion 5.

### BACKGROUND

### Field of the Invention

At least an embodiment of the present invention relates to a card reader.

### Description of the Related Documents

A card reader capable of accessing information recorded on a card is described in Japanese Unexamined Patent Application Publication No. 2019-066211. The card reader of Japanese Unexamined Patent Application Publication No. 2019-066211 is attached to a mounting surface inside a case of an information device. The card reader includes a cover member formed with an insertion slot for inserting a card, and a card reader main body portion capable of accessing information recorded on the card inserted through the insertion slot. The cover member includes a protruding portion protruding forward, and the insertion slot is formed in the protruding portion. When the card reader is attached to the inside of the case of the information device, the protruding portion is exposed to the outside from the case of the information device. The card used is a credit card or the like.

In the card reader of Japanese Unexamined Patent Application Publication No. 2019-066211, when a user inserts a card into the insertion slot, an end portion of the card may contact a front surface of the cover member. In addition, a nail of the user or the like may contact the front surface of the cover member. In such a case, a surface of the cover member may be damaged by the end portion of the card or the like. In particular, when the surface of the cover member is provided with a coating, scratches on the surface of the cover member become conspicuous, thereby impairing the aesthetic appearance of the cover member.

In view of the above issues, an object of at least an embodiment of the present invention is to provide a card reader in which a surface of a cover member is less likely to be scratched.

### SUMMARY

To address the above-described issues, an aspect of the card reader of at least an embodiment of the present invention is characterized by including: a cover member including a front wall portion in which an insertion slot for inserting a card is formed; and a card reader main body portion capable of accessing information recorded on the card inserted through the insertion slot, wherein a hard coat layer is provided on a front surface of the front wall portion and a surface of an opening edge portion forming the insertion slot.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view of a card reader according to the present embodiment;

FIG. 2 is a cross-sectional view of the card reader;

FIG. 3 is a front view of a cover member;

FIG. 4 is a cross-sectional view for explaining a hole portion; and

FIG. 5 is a view for explaining a hard coat layer and a water-repellent layer.

### DETAILED DESCRIPTION

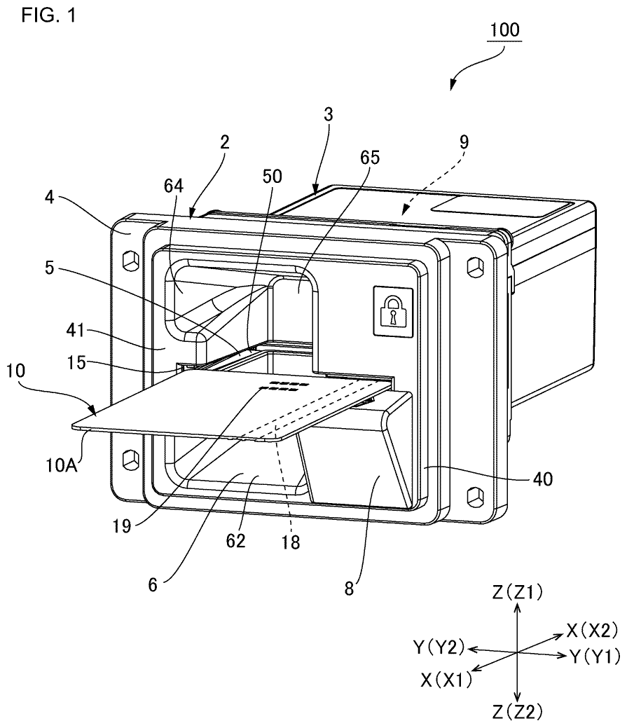

Hereinafter, at least an embodiment of the present invention will be described with reference to the drawings. In the following description, a card 10 moves in a front-rear direction X illustrated in FIG. 1. An up-down direction Z is a thickness direction of the card 10, and a left-right direction Y is a direction orthogonal to the front-rear direction X and the up-down direction Z. In the following description, a front side is denoted by X1, a rear side is denoted by X2, a right side is denoted by Y1, a left side is denoted by Y2, an upper side is denoted by Z1, and a lower side is denoted by Z2.

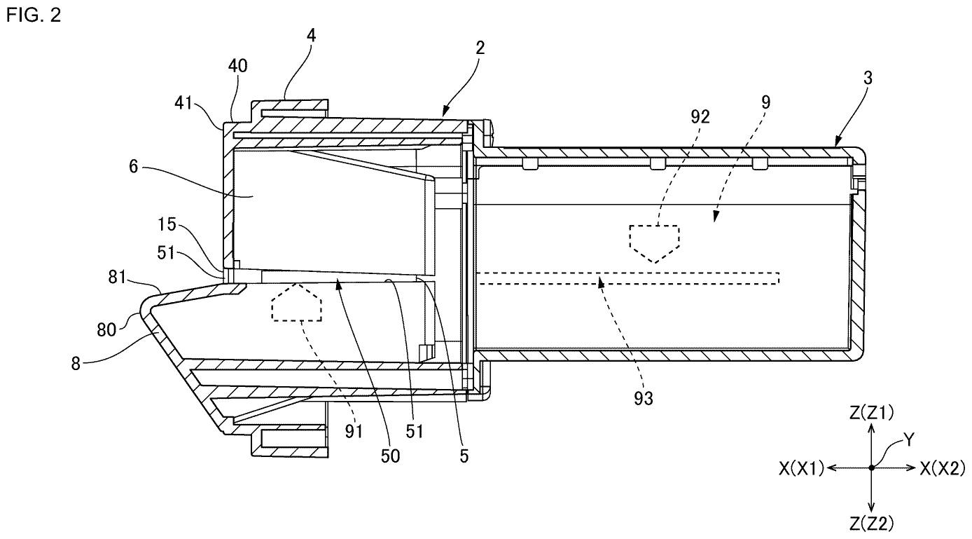

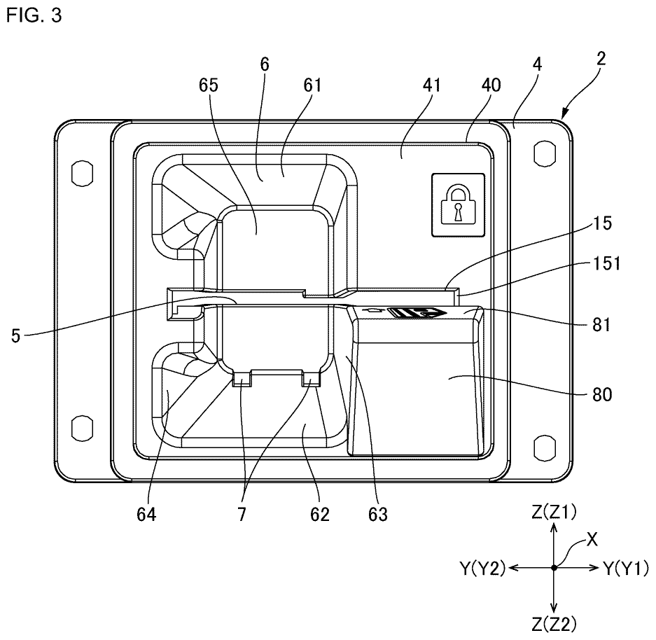

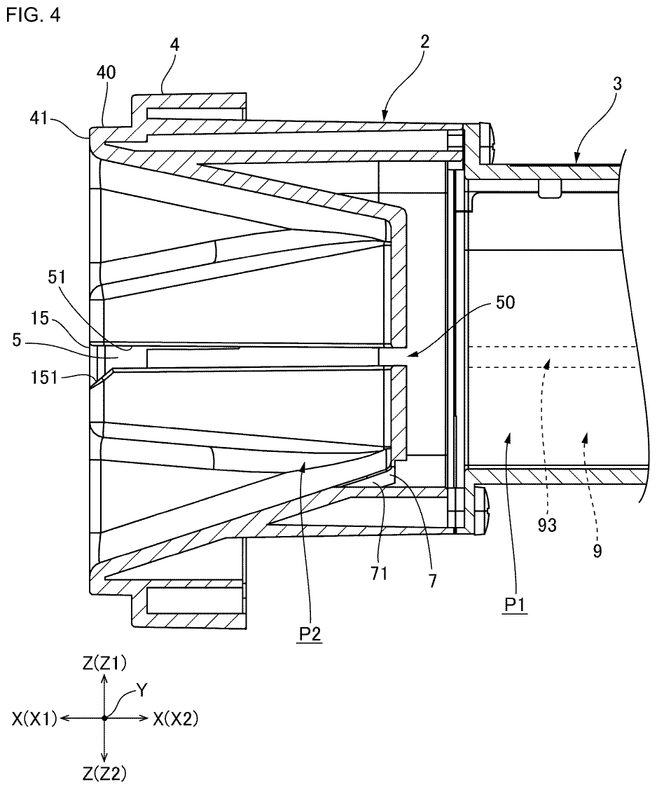

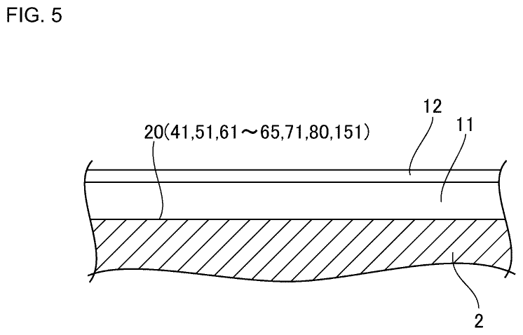

FIG. 1 is a perspective view of a card reader 100 according to the present embodiment. FIG. 2 is a cross-sectional view of the card reader 100. FIG. 3 is a front view of a cover member. FIG. 4 is a cross-sectional view for explaining a hole portion. FIG. 5 is a view for explaining a hard coat layer and a water-repellent layer.

The card reader 100 is attached to a transaction device such as a payment machine of a parking lot or a drive-through ATM. The card reader 100 reads magnetic data or electronic data recorded on the card 10. As illustrated in FIG. 1, in the card reader 100, after the card 10 is inserted from the front side X1, the card 10 is withdrawn toward the front side X1. The card reader 100 is controlled by a host device provided in the transaction device.

The card 10 is, for example, a rectangular thin card having a thickness of about 0.7 to 0.8 mm, and is made of plastic, such as vinyl chloride, or is made of metal. The card 10 is, for example, a credit card. A magnetic stripe 18 on which magnetic data is recorded is formed on a surface of the lower side Z2 of the card 10. An IC chip 19 is provided on a surface of the upper side Z1 of the card 10.

The card reader 100 includes a cover member 2 including a front wall portion 4 in which an insertion slot 15 for inserting the card 10 is formed, a card reader main body portion 9 capable of accessing information recorded on the card 10 inserted through the insertion slot 15, and a case 3 connected to the rear side X2 of the cover member 2 and accommodating the card reader main body portion 9. As illustrated in FIG. 2, the card reader main body portion 9 includes a magnetic reading unit 91 arranged on the rear side X2 of the front wall portion 4, and an IC reading unit 92 arranged on the rear side X2 of the magnetic reading unit 91 and accommodated inside the case 3. The magnetic reading unit 91 is, for example, a magnetic head, and reads magnetic data recorded on the magnetic stripe 18 of the card 10. The IC reading unit 92 reads electronic data recorded on the IC chip 19 by coming into contact with the IC chip 19. Note that the card reader main body portion 9 may include a transport mechanism for transporting the card 10 into the inside of the card reader main body portion 9.

The cover member 2 is made of resin. A surface of the cover member 2 is provided with a coating. As illustrated in FIGS. 1 to 4, the cover member 2 includes the front wall portion 4, a guide portion 5 forming a transport path 50, a recessed portion 6 recessed from the front wall portion 4 toward the rear side X2, a hole portion 7 formed in the recessed portion 6, and a convex portion 8 provided on the front wall portion 4. The front wall portion 4 includes a protruding portion 40 protruding toward the front side X1. When the card reader 100 is attached to the transaction device, the protruding portion 40 is exposed to the outside from an opening formed in a case of the transaction device. Therefore, a front surface 41 of the protruding portion 40 becomes an exterior portion of the transaction device. The insertion slot 15 is an opening that is long in the left-right direction Y. The guide portion 5 extends from the insertion slot 15 toward the rear side X2. The guide portion 5 has a slit shape. The transport path 50 of the guide portion 5 is connected to a transport path 93 formed in the card reader main body portion 9.

The recessed portion 6 has a shape in which a portion other than a portion through which both ends of the card 10 pass is hollowed out. The recessed portion 6 forms a rectangular opening when viewed from the front side X1. The recessed portion 6 is surrounded by four inner peripheral surfaces 61 to 64. The guide portion 5 is formed on the inner peripheral surface 63 on the right side Y1, the inner peripheral surface 64 on the left side Y2, and an inner peripheral surface 65 on the rear side X2. The inner peripheral surface 62 on the lower side Z2 is inclined to the lower side Z2 toward the front side X1. In the present embodiment, when the card 10 is inserted into the insertion slot 15, a rear end portion 10A of the card 10 protrudes from the inner peripheral surface 65 on the rear side X2 toward the front side X1. That is, both surfaces of the rear end portion 10A of the card 10 are exposed inside the recessed portion 6. Accordingly, since a space for inserting fingertips and pinching the rear end portion 10A of the card 10 is secured on both sides of the rear end portion 10A of the card 10 in the up-down direction Z, when the card reader main body portion 9 includes the transport mechanism for transporting the card 10 into the inside of the card reader main body portion 9, even if a power failure or a malfunction occurs in the card reader 100 after the card 10 is inserted and transport of the card 10 becomes impossible, the user can manually pull out the card 10.

The hole portion 7 penetrates the recessed portion 6 in the front-rear direction X at a position connected to the inner peripheral surface 62 on the lower side Z2 of the recessed portion 6. The hole portion 7 connects a space P1 in which the card reader main body portion 9 is located and an internal space P2 of the recessed portion 6. Accordingly, when the card 10 to which water droplets adhere is inserted through the insertion slot 15, even if the water droplets accumulate in the space P1, the water droplets are discharged from the hole portion 7 into the internal space P2.

The convex portion 8 protrudes from the front surface 41 of the front wall portion 4 toward the front side X1. The convex portion 8 has a substantially triangular shape when viewed from the left-right direction Y. An upper surface 81 of the convex portion 8 is smoothly connected to a bottom surface of the insertion slot 15. Accordingly, when the card 10 is pushed toward the rear side X2 while sliding on the upper surface 81, the card 10 can be easily inserted into the insertion slot 15.

The convex portion 8 is provided at a position adjacent to the insertion slot 15. Specifically, the convex portion 8 is provided at a position on the lower side Z2 on the right side Y1 of the insertion slot 15, which is a position adjacent to a portion through which the magnetic stripe 18 of the card 10 inserted into the insertion slot 15 passes. Here, the magnetic reading unit 91 is located on the rear side X2 of the convex portion 8. By providing the convex portion 8 on the front wall portion 4, it becomes difficult to attach a magnetic data skimming member around the insertion slot 15. In the present embodiment, since the convex portion 8 is located on the front side X1 of the magnetic reading unit 91, attachment of the magnetic data skimming member can be made more difficult.

As illustrated in FIG. 5, a hard coat layer 11 is provided on the surface 20 of the cover member 2. Specifically, the hard coat layer is provided on a surface including the front surface 41 of the protruding portion 40 of the front wall portion 4, a surface 151 of the opening edge portion of the insertion slot 15, a surface 51 of the guide portion 5, the inner peripheral surfaces 61 to 65 of the recessed portion 6, an inner peripheral surface 71 of the hole portion 7, and a surface 80 of the convex portion 8. The hard coat layer 11 is made of, for example, a photocurable resin made of acrylic and/or urethane. Further, the hard coat layer 11 may contain silica particles. Note that the hard coat layer 11 may be, for example, a thermosetting resin.

As illustrated in FIG. 5, a water-repellent layer 12 is provided on a surface of the hard coat layer 11. The water-repellent layer 12 is made of, for example, a fluorine-containing silane compound. The fluorine-containing silane compound is applied to the surface of the hard coat layer 11 after being made into a water-repellent treatment liquid dissolved in an organic solvent.

### Operation and Effect

The card reader 100 includes the cover member 2 including the front wall portion 4 in which the insertion slot 15 for inserting the card 10 is formed, and the card reader main body portion 9 capable of accessing information recorded on the card 10 inserted through the insertion slot 15. The hard coat layer 11 is provided on the front surface 41 of the front wall portion 4 and the surface 51 of the opening edge portion forming the insertion slot 15.

Accordingly, when a user inserts the card into the insertion slot 15, even if the end portion of the card 10, a nail of the user, or the like contacts the front surface 41 of the front wall portion 4 or the surface 51 of the opening edge portion, the surface of the cover member 2 is less likely to be scratched. Therefore, it is possible to suppress impairment of the aesthetic appearance of the cover member 2.

The cover member 2 includes the guide portion 5 forming the transport path 50 extending from the insertion slot 15 toward the rear side X2. The hard coat layer 11 is provided on the surface 51 of the guide portion 5. Accordingly, when the card 10 passes through the transport path 50, even if an end portion of the card 10 contacts the surface 51 of the guide portion 5, a coating applied to the surface 51 of the guide portion 5 is less likely to be peeled off. Here, when the coating on the surface 51 of the guide portion 5 is peeled off, the peeled coating may be taken into the card reader main body portion 9 together with the transport of the card 10 and may adhere to the IC reading unit 92. When the peeled coating adheres to the IC reading unit 92, the IC reading unit 92 may not be able to correctly read information in the IC chip 19 of the card 10. Therefore, since the coating applied to the surface 51 of the guide portion 5 is less likely to be peeled off due to the hard coat layer 11, the IC reading unit 92 can correctly read the information in the IC chip 19 of the card 10.

The cover member 2 includes: the recessed portion 6 recessed from the front wall portion 4 toward the rear side X2 and exposing, inside, both surfaces of the rear end portion 10A of the card inserted along the transport path 50 toward the rear side X2; the hole portion 7 penetrating the recessed portion 6 in the front-rear direction X at a position connected to the inner peripheral surface 62 on the lower side of the recessed portion 6 and connecting the space P1 in which the card reader main body portion 9 is located and the internal space P2 of the recessed portion; and the convex portion 8 provided at a position adjacent to the insertion slot 15 on the front surface 41 of the front wall portion 4 and protruding toward the front side X1. The hard coat layer 11 is provided on the inner peripheral surfaces 61 to 65 of the recessed portion 6, the inner peripheral surface 71 of the hole portion 7, and the surface 80 of the convex portion 8. Accordingly, the surface of the cover member 2 is less likely to be scratched. Therefore, it is possible to suppress impairment of the aesthetic appearance of the cover member 2.

The water-repellent layer 12 is provided on the surface of the hard coat layer 11. Accordingly, even if water droplets adhere to the surface of the cover member 2, the water droplets easily flow downward. Further, since the water-repellent layer 12 is provided on the inner peripheral surface 71 of the hole portion 7, when the card 10 to which water droplets adhere is inserted through the insertion slot 15, even if the water droplets accumulate in the space P1, the water droplets are easily discharged from the hole portion 7 into the internal space P2.

A film thickness HC of the hard coat layer 11 satisfies the following conditional expression: 2 μm≤HC≤30 μm. Further, preferably, the film thickness HC satisfies 5 μm≤HC≤20 μm. More preferably, the film thickness HC satisfies 10 μm≤HC≤20 μm. Accordingly, the hardness of the hard coat layer 11 can be appropriately set. Here, when the value of the conditional expression exceeds the upper limit, the hardness of the hard coat layer 11 can be increased, but thermal shock resistance performance decreases. When the value of the conditional expression falls below the lower limit, the hardness of the hard coat layer 11 cannot be increased.

The hard coat layer 11 contains silica particles. When a content rate of the silica particles in the hard coat layer 11 is S, the content rate S satisfies the following conditional expression: 40%≤S≤65%. Accordingly, the hardness of the hard coat layer 11 can be increased. Here, when the value of the conditional expression exceeds the upper limit, the hardness of the hard coat layer 11 can be increased, but thermal shock resistance performance decreases. When the value of the conditional expression falls below the lower limit, the hardness of the hard coat layer 11 cannot be increased.

Here, in the hard coat layer 11 of the present embodiment, the film thickness of the hard coat layer provided on the surface 151 of the opening edge portion and the film thickness of the hard coat layer provided on the surface 51 of the guide portion 5 are thinner than the film thickness of the hard coat layer provided on the front surface 41. For example, the film thickness of the hard coat layer provided on the surface 151 of the opening edge portion and the film thickness of the hard coat layer provided on the surface 51 of the guide portion 5 are about half of the film thickness of the hard coat layer provided on the front surface 41. Accordingly, in the insertion slot 15 and the guide portion 5, where scratches are less likely to occur, by thinning the film thickness of the hard coat layer provided on the surface 151 of the opening edge portion and the film thickness of the hard coat layer provided on the surface 51 of the guide portion 5, it is possible to suppress a range of variation in the film thickness of the hard coat layer provided on the surface 151 of the opening edge portion and the film thickness of the hard coat layer provided on the surface 51 of the guide portion 5. As a result, while increasing the hardness of the hard coat layer 11 on the front surface 41, where scratches are likely to occur, it is possible to suppress variation in gap intervals in the up-down direction Z and the left-right direction Y of the insertion slot 15 and the guide portion 5, so that the card 10 can be smoothly inserted through the insertion slot 15.

The hard coat layer 11 is a photocurable resin. Accordingly, the hard coat layer 11 can be easily formed by applying a photocurable resin material by spraying or the like and then irradiating the photocurable resin material with UV light or the like.

### Modifications

The cover member 2 is not limited to the above-described embodiment. The cover member 2 may not include the recessed portion 6. Further, the cover member 2 may not include the convex portion 8.

In the above-described embodiment, the water-repellent layer 12 is provided on the surface of the hard coat layer 11, but the water-repellent layer 12 may not be provided. In this case, the hard coat layer 11 preferably has a static contact angle of 90 degrees or more. Accordingly, even if the water-repellent layer 12 is not separately provided on the surface of the hard coat layer 11, the hard coat layer 11 itself can have water repellency.

Note that the present technology can be configured as follows.

### Supplementary Note 1

A card reader including:
a cover member including a front wall portion in which an insertion slot for inserting a card is formed; and
a card reader main body portion capable of accessing information recorded on the card inserted through the insertion slot,
wherein a hard coat layer is provided on a front surface of the front wall portion and a surface of an opening edge portion forming the insertion slot.

### Supplementary Note 2

The card reader according to Supplementary Note 1, wherein
the cover member includes a guide portion forming a transport path extending rearward from the insertion slot, and
the hard coat layer is provided on a surface of the guide portion.

### Supplementary Note 3

The card reader according to Supplementary Note 2, wherein
the cover member includes a recessed portion that is recessed rearward from the front wall portion and that exposes, inside, both surfaces of a rear end portion of the card inserted rearward along the transport path, and
the hard coat layer is provided on an inner peripheral surface of the recessed portion.

### Supplementary Note 4

The card reader according to Supplementary Note 3, wherein
the cover member includes a hole portion that penetrates the recessed portion in a front-rear direction at a position connected to the inner peripheral surface on a lower side of the recessed portion and that connects a space in which the card reader main body portion is located and an internal space of the recessed portion, and
the hard coat layer is provided on an inner peripheral surface of the hole portion.

### Supplementary Note 5

The card reader according to any one of Supplementary Notes 1 to 4, wherein
the cover member includes a convex portion that is provided at a position adjacent to the insertion slot on the front surface of the front wall portion and that protrudes forward, and
the hard coat layer is provided on a surface of the convex portion.

### Supplementary Note 6

The card reader according to any one of Supplementary Notes 1 to 5,
wherein a film thickness HC of the hard coat layer satisfies the following conditional expression:

$$2 μ m \leq HC \leq 30 μ m .$$

### Supplementary Note 7

The card reader according to any one of Supplementary Notes 1 to 6, wherein
the hard coat layer contains silica particles, and
when a content rate of the silica particles in the hard coat layer is S, the content rate S satisfies the following conditional expression:

$$40 \% \leq S \leq 65 \% .$$

### Supplementary Note 8

The card reader according to any one of Supplementary Notes 1 to 7, wherein the hard coat layer is a photocurable resin.

### Supplementary Note 9

The card reader according to any one of Supplementary Notes 1 to 8, wherein a water-repellent layer is provided on a surface of the hard coat layer.

### Supplementary Note 10

The card reader according to any one of Supplementary Notes 1 to 8, wherein the hard coat layer has a static contact angle of 90 degrees or more.

What is claimed is:

1. A card reader, comprising:
a cover member including a front wall portion in which an insertion slot for inserting a card is formed; and
a card reader main body portion capable of accessing information recorded on the card inserted through the insertion slot,
wherein a hard coat layer is provided on a front surface of the front wall portion and a surface of an opening edge portion forming the insertion slot.

2. The card reader according to claim 1, wherein
the cover member includes a guide portion forming a transport path extending rearward from the insertion slot; and
a hard coat layer is provided on a surface of the guide portion.

3. The card reader according to claim 2, wherein
the cover member includes a recessed portion that is recessed rearward from the front wall portion and that exposes, inside, both surfaces of a rear end portion of the card inserted rearward along the transport path, and
the hard coat layer is provided on an inner peripheral surface of the recessed portion.

4. The card reader according to claim 3, wherein
the cover member includes a hole portion that penetrates the recessed portion in a front-rear direction at a position connected to the inner peripheral surface on a lower side of the recessed portion and that connects a space in which the card reader main body portion is located and an internal space of the recessed portion, and
the hard coat layer is provided on an inner peripheral surface of the hole portion.

5. The card reader according to claim 1, wherein
the cover member includes a convex portion that is provided at a position adjacent to the insertion slot on the front surface of the front wall portion and that protrudes forward, and
the hard coat layer is provided on a surface of the convex portion.

6. The card reader according to claim 1,
wherein a film thickness HC of the hard coat layer satisfies the following conditional expression:
$$2 μ m \leq HC \leq 30 μ m .$$

7. The card reader according to claim 1, wherein
the hard coat layer contains silica particles, and
when a content rate of the silica particles in the hard coat layer is S, the content rate S satisfies the following conditional expression:
$$40 \% \leq S \leq 65 \% .$$

8. The card reader according to claim 1, wherein the hard coat layer is a photocurable resin.

9. The card reader according to claim 1, wherein a water-repellent layer is provided on a surface of the hard coat layer.

10. The card reader according to claim 1, wherein the hard coat layer has a static contact angle of 90 degrees or more.

11. The card reader according to claim 2, wherein
the cover member includes a convex portion that is provided at a position adjacent to the insertion slot on the front surface of the front wall portion and that protrudes forward, and
the hard coat layer is provided on a surface of the convex portion.

12. The card reader according to claim 3, wherein
the cover member includes a convex portion that is provided at a position adjacent to the insertion slot on the front surface of the front wall portion and that protrudes forward, and
the hard coat layer is provided on a surface of the convex portion.

13. The card reader according to claim 4, wherein
the cover member includes a convex portion that is provided at a position adjacent to the insertion slot on the front surface of the front wall portion and that protrudes forward, and
the hard coat layer is provided on a surface of the convex portion.

14. The card reader according to claim 4,
wherein a film thickness HC of the hard coat layer satisfies the following conditional expression:
$$2 μ m \leq HC \leq 30 μ m .$$

15. The card reader according to claim 14, wherein
the hard coat layer contains silica particles, and
when a content rate of the silica particles in the hard coat layer is S, the content rate S satisfies the following conditional expression:
$$40 \% \leq S \leq 65 \% .$$

16. The card reader according to claim 15, wherein the hard coat layer is a photocurable resin.

17. The card reader according to claim 16, wherein a water-repellent layer is provided on a surface of the hard coat layer.

18. The card reader according to claim 17, wherein the hard coat layer has a static contact angle of 90 degrees or more.
